(19) United States
(12) Patent Application Publication
(10) Pub. No.: US 2004/0098324 A1
(43) Pub. Date: May 20, 2004

(54) System and method for providing budgets for vehicle sales using a mobile computing device

(76) Inventor: Yung-Wei Chen, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/405,254

(22) Filed: Apr. 1, 2003

(30) Foreign Application Priority Data
Nov. 15, 2002 (TW) 91133438

(51) Int. Cl. G06F 17/60

(52) U.S. Cl. 705/35

(57) ABSTRACT

A system for providing budgets for vehicle sales using a mobile computing device includes a database server (107), an application server (103) to access and handle information stored in the database server, and mobile terminals (101) connected with the application server by a communication channel (115, 113). Each mobile terminal includes a budget module (306), a link-switching module (303), a data synchronization module (309), a data filter manager module (307), and a data storage (310). The link-switching module is for switching states of connection as between the mobile terminal and the application server. The budget module is for calculating fees relating to vehicles using budget definition information stored in the data storage. The data synchronization module is for downloading information for synchronization from the application server. The data filter manager module is for filtering modification of data in the data storage, said modification performed when the mobile terminal is disconnected.

### BACKGROUND OF THE INVENTION

1. Field of the Invention

The present invention relates to a system and method for vehicle sales using a mobile computing device, and particularly to a system and a method which provide budgets for vehicle sales.

2. Description of Related Art

By using mobile computing apparatuses, customers can connect with e-mail servers, website servers, online banks and other application apparatuses located in remote database servers of various corporations. Many corporations have realized the potential competitive advantages of connecting their systems and servers via mobile computing apparatuses. These corporations endeavor to extend and enhance performance of tasks and customer relations by providing employees and clients with remote communication user interfaces and systems.

In particular, following the development of portable electronic devices and wireless communications technology, corporations in a variety of commercial fields seek effective information exchange between portable electronic devices of employees or customers and systems or servers of corporations. All involved strive to not only save money, but also to extend and improve their respective competitive advantages.

U.S. Pat. No. 6,125,356 granted on Sep. 26, 2000 and entitled “Portable sales presentation system with selective scripted seller prompts” discloses a handheld computer unit for use by, for example, a car salesperson. The computer unit prompts the salesperson with a standard script to be followed at each step in a sales process once a prospective customer has entered a car dealership.

The above-described portable sales presentation system merely employs a standard script. Said system cannot be used to assist the entire process of selling vehicles through to tasks such as calculating fees applicable to vehicles reserved by a customer. In particular, there is no means for calculating a suitable purchase budget for the customer to consider and follow if desired. In addition, the information in the computer unit cannot be updated automatically.

### SUMMARY OF THE INVENTION

An object of the present invention is to provide a system for providing budgets for vehicle sales using a mobile computing device, in which the system enables a seller to calculate fees of vehicles reserved by a client.

Another object of the present invention is to provide a method for providing budgets for vehicle sales using a mobile computing device, in which the system enables a seller to calculate fees of vehicles reserved by a client.

To achieve the first above-mentioned objective, a preferred embodiment of a system of the present invention for providing budgets for vehicle sales using a mobile computing device comprises an application server, a database server connected with the application server by a network, and a plurality of mobile terminals connected with the application server by a communication channel. Each mobile terminal comprises a budget module, a link-switching module, a data synchronization module, a data filter manager module, and a data storage. The data storage is used for storing information on clients, vehicles, employees and budget definitions. The link-switching module is used for switching states of connection as between the mobile terminal and the application server, said states of connection comprising a connected state and a disconnected state. The budget module is used for calculating fees relating to vehicles reserved by a client using budget definition information stored in the data storage. The data synchronization module is used for downloading information for synchronization from the application server, and for storing the downloaded information in the data storage. The data filter manager module is used for filtering modification of data stored in the data storage, said modification performed when the mobile terminal is in the disconnected state, and for sending data thus modified to the data synchronization module.

To achieve the second above-mentioned objective, a preferred method of the present invention for providing budgets for vehicle sales using a mobile computing device comprises the following steps: (a) selecting from a data storage information on vehicles reserved by a client, including information on fees relating to the vehicles; (b) selecting budgetary parameters; (c) generating a budget plan menu for the client to conveniently select a budget plan best suited for him/her; and (d) using preset formulas to calculate fees payable in relation to the vehicles, and displaying a budget plan result on a screen of the mobile computing device.

Other objects, advantages and novel features of the present invention will be drawn from the following detailed description of preferred embodiments of the present invention with the attached drawings, in which:

### BRIEF DESCRIPTION OF THE DRAWINGS

FIG. 1 schematically shows hardware infrastructure of a system for providing budgets for vehicle sales using a mobile computing device in accordance with a preferred embodiment of the present invention;

FIG. 2 schematically shows hardware infrastructure of a system for providing budgets for vehicle sales using a mobile computing device in accordance with an alternative embodiment of the present invention;

FIG. 3 is a block diagram of software infrastructure of an application server of the system of the present invention;

FIG. 4 is a block diagram of software infrastructure of a PDA (Personal Digital Assistant) of the system of the present invention;

FIG. 5 is a schematic drawing of software infrastructure of an information searching module of the PDA of FIG. 4;

FIG. 6 is a schematic diagram of software infrastructure of a budget module of the PDA of FIG. 4;

FIG. 7 schematically illustrates an exemplary homepage display on a screen of the PDA of the system of the present invention;

FIG. 8 is similar to FIG. 7, but showing a connection switch icon of the homepage display displayed differently;

FIG. 9 is a flowchart of a preferred method for providing a budget for vehicle sales using a mobile computing device, in accordance with the present invention;

FIG. 10 is a flowchart of downloading information from a database server to a PDA, in accordance with one step of FIG. 9 regarding synchronizing information; and

FIG. 11 is a flowchart of details of two steps of FIG. 9, namely generating a budget plan menu and calculating a budget plan result.

### DETAILED DESCRIPTION OF THE INVENTION

Reference will now be made to the drawing figures to describe the present invention in detail.

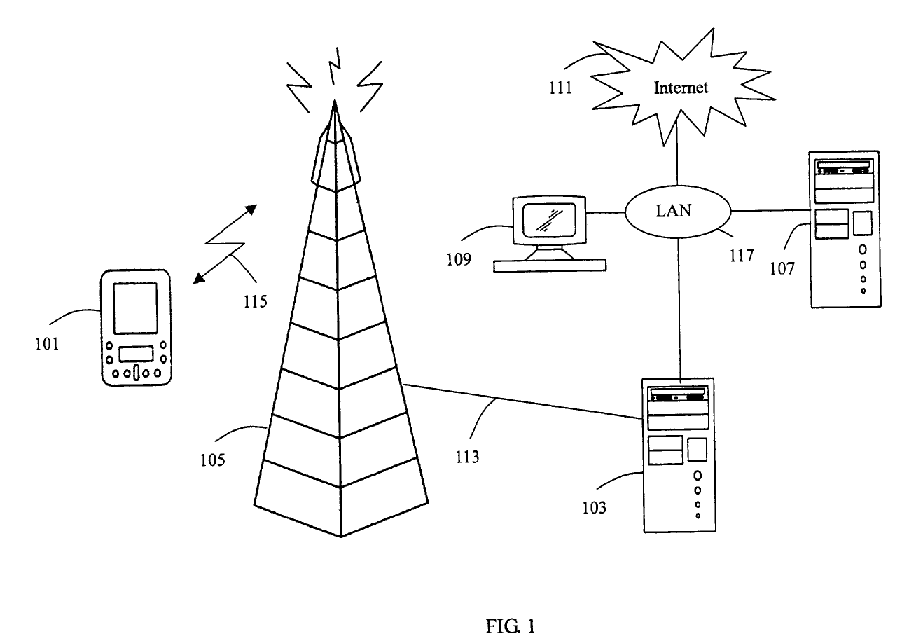

FIG. 1 schematically shows hardware infrastructure of a system for providing budgets for vehicle sales using a mobile computing device in accordance with the preferred embodiment of the present invention. The system for providing budgets for vehicle sales is implemented in a corporate information system that comprises a three-level structure: distributed foreground workstations, an application server, and a central database server. In the present invention, each foreground workstation is a mobile computing apparatus such as a PDA (Personal Digital Assistant), a laptop computer, or a smart phone. In the preferred embodiment of the present invention, each mobile computing apparatus is a PDA 101 (only one shown). In the preferred embodiment of the present invention, users of the PDAs 101 are sellers who process tasks related to selling of vehicles. The application server 103 comprises core and changeable information, and includes programming, operation means, management modules and so on. The application server 103 receives information input from the PDAs 101, processes the information, and returns results to the PDAs 101. A database server 107 manages reading, writing and maintenance of information in an associated database (not shown), and executes updating and searching of information in the database. The database may be located in the database server 107, or may be separate from but connected with the database server 107 via a connection. In the preferred embodiment of the present invention, relevant information includes vehicle information, vehicle delivery information, client information and budget plan information.

A communication tower 105 communicates with each PDA 101 and the application server 103 via a communication channel 115 and a communication channel 113, and transmits inquiry information from the PDA 101 and results information from the application server 103. In the preferred embodiment of the present invention illustrated in FIG. 1, the PDA 101 communicates with the communication tower 105 by using a data machine (not shown). The communication tower 105 connects with the application server 103 via the communication channel 113. The communication channel 113 may be private or public, and may be a hardwired channel or a wireless channel. The application server 103 connects with the database server 107 via a network 117. In the preferred embodiment of the present invention, the network 117 is a LAN (Local Area Network) 117. The LAN 117 connects with a computer terminal 109 for providing means to visit the Internet 111. The PDA 101 also can visit the Internet 111 via the LAN 117, the application server 103, the communication channel 113 and the communication channel 115. In an alternative embodiment of the present invention, the corporate information system may comprise a distributed structure in which there are two or more application servers 103 and two or more database servers 107.

The above-described corporate information system is provided to illustrate the preferred embodiment of the present invention. In alternative embodiments of the present invention, other systems derived from the above-described corporate information system may be used. In addition, other systems may be used to implement the method of the present invention.

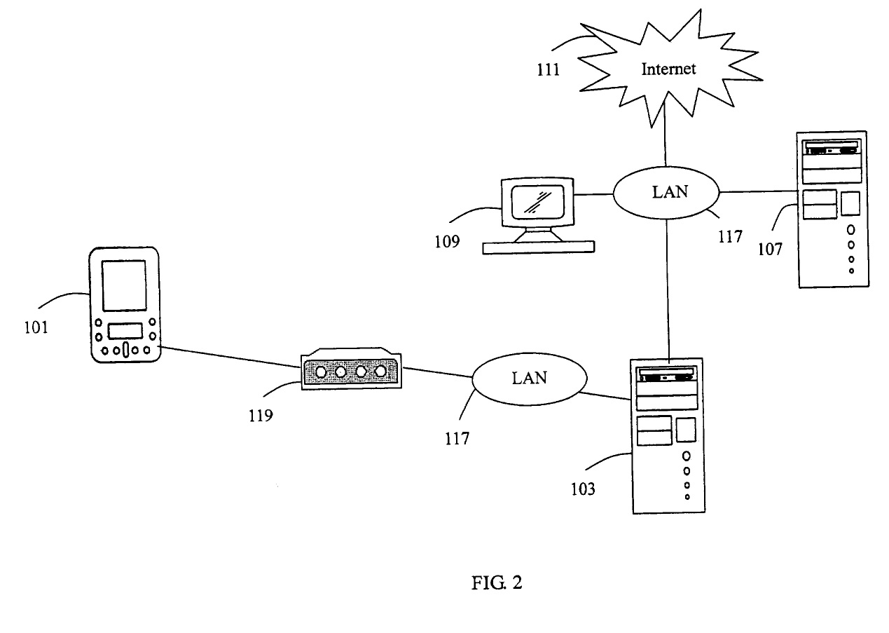

FIG. 2 schematically shows hardware infrastructure of a system for providing budgets for vehicle sales using a mobile computing device in accordance with an alternative embodiment of the present invention. In this alternative embodiment, the connection between the PDA 101 and the application server 103 is via a hardwired channel. When a user can access the LAN 117, this connection provides better and more reliable transmission of information. The PDA 101 connects with the LAN 117 via an Ethernet card 119, and connects with the application server 103 and the database server 107 via the LAN 117. In other respects, the hardware infrastructure of the system for providing budgets for vehicles sales in accordance with the alternative embodiment is similar to that of the preferred embodiment.

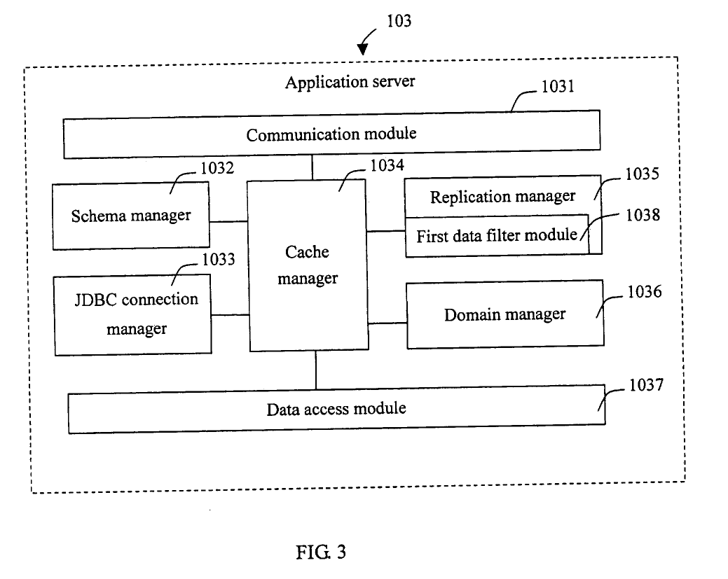

FIG. 3 is a block diagram of software infrastructure of the application server 103. In the preferred embodiment of the present invention, the application server 103 uses a Java Servlet engine structure to set up communication mechanisms for data interchange with the PDA 101 and the database server 107. The application server 103 can also use other structures to communicate with the PDA 101 and the database server 107. The Java servlet corresponds to an applet for extending to website browsing, and is a group of program codes for enhancing a Java application server. A characteristic of Java is that it can extend and connect different background systems more easily. The Java application server can accept a new servlet without modification. Under the structure of the servlet, the system for providing budgets for vehicle sales needs to download the new servlet once only, on the occasion when the system for providing budgets for vehicle sales is used for the first time.

In the preferred embodiment of the present invention, the application server 103 comprises: a communication module 1031, a schema manager 1032, a JDBC (Java Database Connectivity) connection manager 1033, a cache manager 1034, a replication manager 1035, a domain manager 1036 and a data access module 1037.

The communication module 1031 is used to communicate with the PDA 101. The application server 103 can receive information sent by the PDA 101 (such as requirement information), and transmit relevant feedback information to the PDA 101 by using the communication module 1031.

The cache manager 1034 is used to provide cache information as required in accordance with LRU (Least Recently Used) logic, and to receive relevant feedback information sent by the PDA 101 and the database server 107.

The JDBC connection manager 1033 can preset a JDBC connection, and manage the connection with the database server 107. Such management comprises obtaining an immediate connection, obtaining a connection delayed, and cutting all connections upon shutdown. Management may also comprise processing failures of connection and communication.

The replication manager 1035 is used to control mutual updating tasks of the PDA 101 and the database server 107, and to detect and arbitrate conflicting information sent by different users from their respective PDAs 101. The replication manager 1035 comprises a first data filter module 1038. The first data filter module 1038 is used to filter information added in the database server 107, or modify existing information in the database server 107 and the PDA 101.

In the preferred embodiment of the present invention, the schema manager 1032 provides two kinds of information schema. That is, a main database schema and a PDA schema, both of which are provided in XML format. The main database schema describes the relationship between the information schema and tables in the database server 107, and the PDA schema simplifies information demanded by different PDAs 101. The schema manager 1032 selects information from the database server 107, applies the information schema, and transmits resulting information to a PDA 101.

The domain manager 1036 is used to manage domains. In the preferred embodiment of the present invention, the information in the database server 107 is structured as a group of domains. A particular domain contains the definition of a particular object, including the individual data elements, or “attributes,” that make up the object. Each attribute has a data type and one or more values. For example, an “account” object may include attributes related to a bank account such as the owner's name, the balance and tax rate information. The type of account balance may be decimal, and a value of the account balance may be 100.00; that is, one hundred dollars. Each of information selectors of the first data filter module 1038 corresponds to one or more domains.

The data access module 1037 is used to communicate with the database server 107, and obtain information from domains via the first data filter module 1038. The data access module 1037 can automatically obtain relevant information and filter information using a data filter, which makes it easier to obtain information.

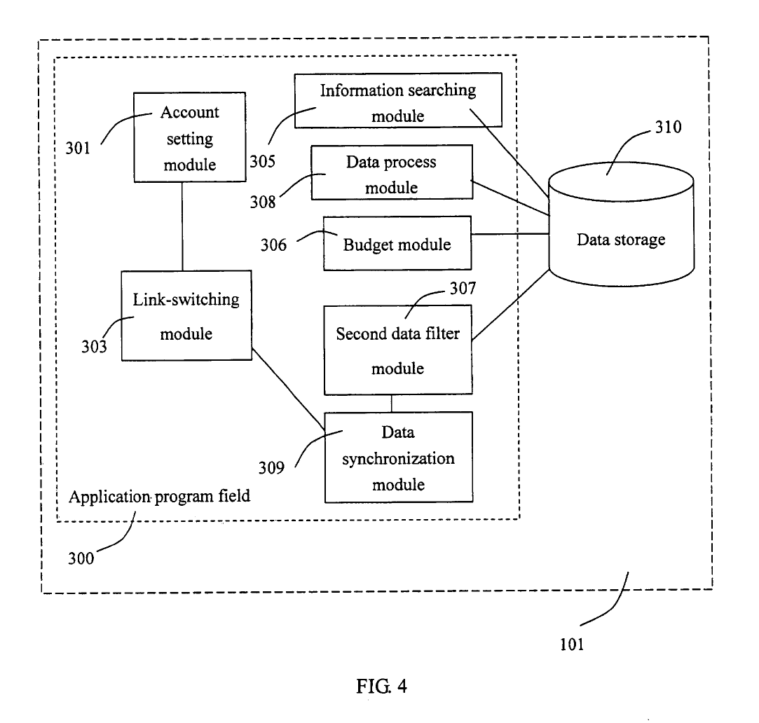

FIG. 4 is a block diagram of software infrastructure of the PDA 101 in accordance with the present invention. The PDA 101 comprises an application program field 300 and a data storage 310. The application program field 300 is used to perform the functions of the PDA 101. The data storage 310 is used to store local information, such as information on clients, vehicles, sellers and budget plans. The application program field 300 comprises an account setting module 301, a link-switching module 303, an information searching module 305, a budget module 306, a second data filter module 307, a data process module 308, and a data synchronization module 309.

The data process module 308, the information searching module 305 and the budget module 306 are all used to process data stored in the data storage 310. The second data filter manager module 307 and the data synchronization module 309 are used to synchronize data of the PDA 101 and the database server 107.

The account setting module 301 is used to set dial-up accounts for connections in regions which the user of the PDA 101 routinely visits. When the user goes to these regions, he/she can use the local dial-up accounts to save on communication costs.

The link-switching module 303 is used to receive connecting or disconnecting orders sent by the user of the PDA 101, and to switch connection between the PDA 101 and the application server 103. In the preferred embodiment of the present invention, there are two states of connection of the PDA 101 with the application server 103; that is, a disconnected state and a connected state. The disconnected state means that the PDA 101 cannot communicate with the application server 103 as there is no effective communication channel set up between them. The connected state means that the PDA 101 can communicate with the application server 103 as there is an effective communication channel set up between them.

The data process module 308 is used to update and add to data stored in the data storage 310. A user can update or add to data only after being authorized to do so.

The information searching module 305 is used to send requirements to the application server 103 for searching of data stored in the database server 107, and to search data in the data storage 310 of the PDA 101.

The budget module 306 is used to calculate fees related to vehicles reserved by clients, and to generate suggested budget plans in table form. The fees comprise installment payments, government fees, and insurance fees.

The data synchronization module 309 can generate a synchronization requirement, which is used to attain data synchronization between the PDA 101 and the database server 107. The requirement comprises two types of operations, downloading of data and uploading of data. The requirement can be sent to the communication module 1031 of the application server 103.

The second data filter manager module 307 is used to filter data stored in the data storage 310 of the PDA 101 which was modified when the PDA 101 was disconnected from the database server 107, and to send the modified data to the database server 107 for synchronizing with data in the database server 107 when the PDA 101 is next connected with the database server 107. The data synchronization module 309 synchronizes the data filtered by the second data filter manager module 307 with the data in the database server 107 when the PDA 101 is connected. The second data filter manager module 307 can also download data from the database server 107 when the PDA 101 is connected.

FIG. 5 is a schematic drawing of software infrastructure of the information searching module 305 of the PDA 101. The information searching module 305 comprises a vehicle information searching sub-module 3050, a vehicle delivery time searching sub-module 3052, a client searching sub-module 3054, and a budget definition searching sub-module 3056. The vehicle information searching sub-module 3050 is used to search for specifications, equipment details, price information, ordering statuses and delivery times of vehicles that a user is in charge of. The vehicle delivery time searching sub-module 3052 is used to search information on delivery times of vehicles according to order forms provided by the user. The information on delivery times comprises order form numbers and delivery dates of contracts. The client searching sub-module 3054 is used to search client information, which comprises name, address, telephone number, vehicle preference and other information. The budget definition searching sub-module 3056 is used to search various kinds of fees and budget plan information. Such fees comprise installment payments, government fees, and insurance fees. Budget plan information comprises various different budget plans, and budget formulas applicable to respective budget plans. Said information is stored in the data storage 310 of the PDA 101, and the information in the data storage 310 can be synchronized with the relevant information stored in the database server 107.

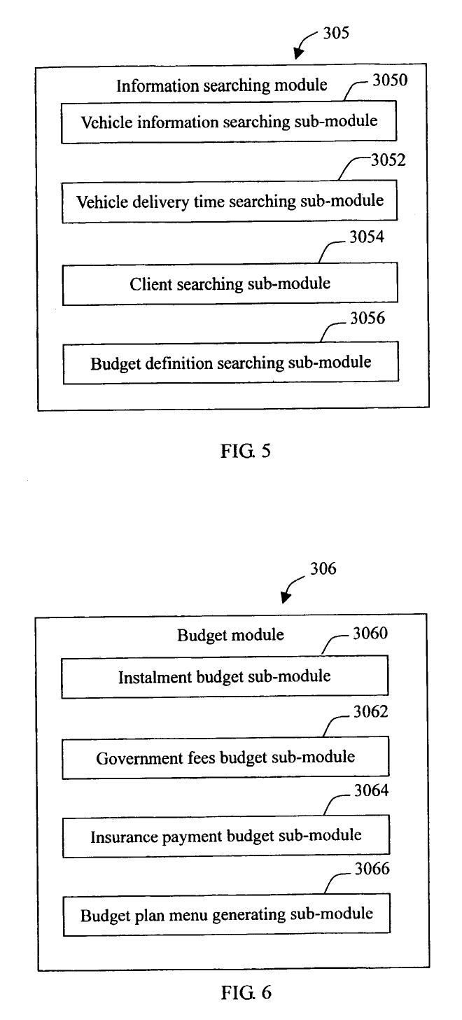

FIG. 6 is a schematic diagram of software infrastructure of the budget module 306 of the PDA 101. The budget module 306 calculates fees related to vehicles reserved by clients, and comprises an installment budget sub-module 3060, a government fees budget sub-module 3062, an insurance payment budget sub-module 3064, and a budget plan menu generating sub-module 3066. The installment budget sub-module 3060 can calculate installment payments payable by a client according to budgetary parameters selected by a user. The government fees budget sub-module 3062 can calculate all government fees such as value-added tax, license plate tax, fuel tax and other fees. The insurance payment budget sub-module 3064 can calculate various kinds of insurance fees. A budget formula is provided for installment payments, each government fee and each insurance fee applicable to vehicles reserved by the client. All the budget formulas are set in advance, and are stored in the data storage 310 of the PDA 101. The budget formulas cannot be modified by the PDA 101. Modification is only permitted by the database server 107, whereupon the modified budget formulas can be synchronized with the budget formulas stored in the PDA 101. The budget plan menu generating sub-module 3066 is used to generate a budget plan menu for the client. The budget plan menu lists all fees relating to vehicles reserved by the client under various budget plans, and allows the client to conveniently select a budget plan best suited for him/her.

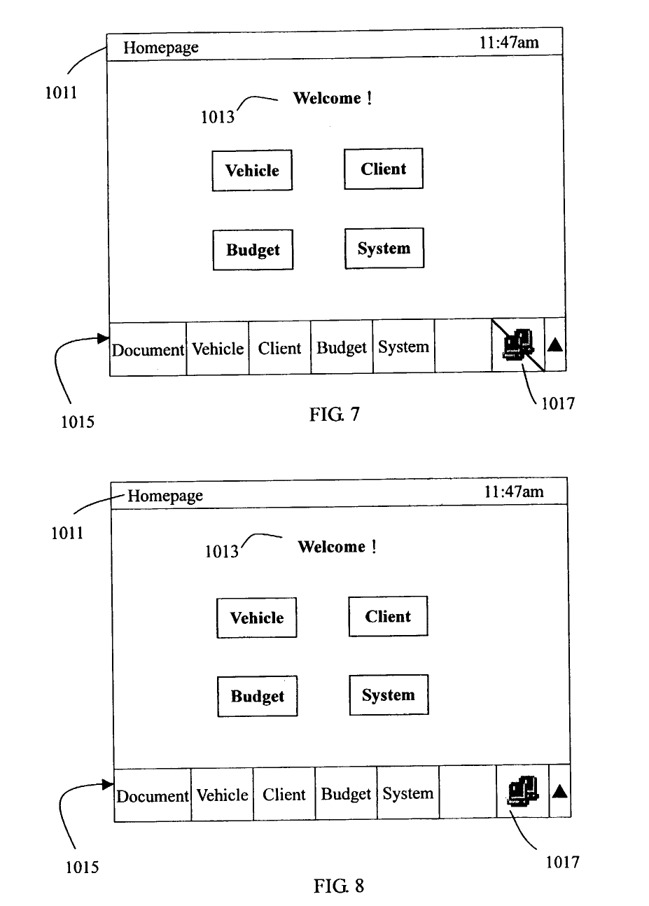

FIGS. 7 and 8 schematically illustrate exemplary homepage displays on the PDA 101, in accordance with the present invention. When a user switches on the PDA 101, the homepage is displayed on a display screen of the PDA 101. On the top of the homepage, there is a title field 1011 that comprises a title “homepage” and a current time “11:47 am.” Under the title field 1011, there is a “Welcome!” message 1013. The message 1013 is preset; and may alternatively be, for example, “Welcome to the system of XX COMPANY!” Under the message 1013, there are several screen icons; namely a vehicle icon, a client icon, a budget icon, and a system icon. The user can browse the information on vehicles stored in the data storage 310, and implement tasks related to vehicles via the vehicle icon. The user can search and maintain information on clients via the client icon. The user can calculate relevant fees relating to vehicles reserved by clients via the budget icon. The user can switch the state of connection of the PDA 101, upload and download information synchronously, and maintain information on sellers via the system icon. Under the screen icons, there is a menu bar 1015 that comprises four selection keys “vehicle,” “client,” “budget” and “system.” These selection keys correspond to the screen icons. The applications represented by the keys are the same as the applications described above in relation to the corresponding screen icons. The user selects a key to implement a desired application by using a stylus. The menu bar 1015 further comprises a “document” key, which enables the user to perform tasks such as opening documents, closing documents and storing documents. Most notably, the menu bar 1015 further comprises a connection switch icon 1017, for indicating the state of connection between the PDA 101 and the application server 103. When the PDA 101 is in the disconnected state, a red slash is displayed across the connection switch icon 1017 (as shown in FIG. 7). In the disconnected state, the PDA 101 cannot communicate with the database server 107, but can manage data in the data storage 310. When the PDA 101 is in the connected state, the red slash is not displayed on the connection switch icon 1017 (as shown in FIG. 8). In the connected state, the PDA 101 can communicate with the database server 107 to download data from the database server 107 and upload data to the database server 107.

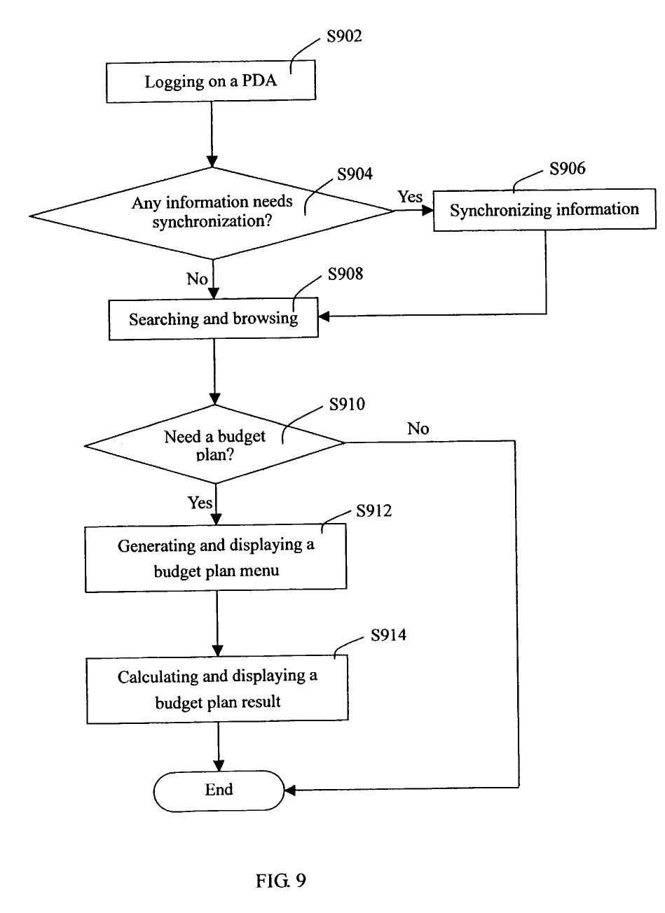

FIG. 9 is a flowchart of a preferred method for providing a budget for vehicle sales using a mobile computing device, in accordance with the present invention. In step S902, a user provides an ID and a password for logging on the PDA 101. This helps prevent unauthorized persons from using the PDA 101. If several successive unsuccessful attempts to log on are performed, the PDA 101automatically deletes information stored in the data storage 310 thereof. In step S904, if the log on is successful, the PDA 101 prompts the user to decide whether he/she has information needing to be synchronized with that in the database server 107. Such information typically comprises client information, vehicle information, budget plans, and other information. If no information needs to be synchronized, the procedure proceeds directly to step S908 described below. If information needs to be synchronized, in step S906, the user connects the PDA 101 with the database server 107, and downloads updating information from the database server 107. At the same time, the PDA 101 can also upload information to the database server 107. The procedure then proceeds to step S908. In step S908, the user searches or browses the information, which comprises vehicle information, client information and other information. In step S910, the user decides whether a budget plan of relevant fees relating to vehicles reserved by a client is needed. If no budget plan is needed, the procedure is ended. If a budget plan is needed, in step S912, a budget plan menu is automatically generated for the client to conveniently select a budget plan best suited for him/her. In step S914, a budget plan result according to the selection of the client is automatically calculated and displayed on the screen of the PDA 101.

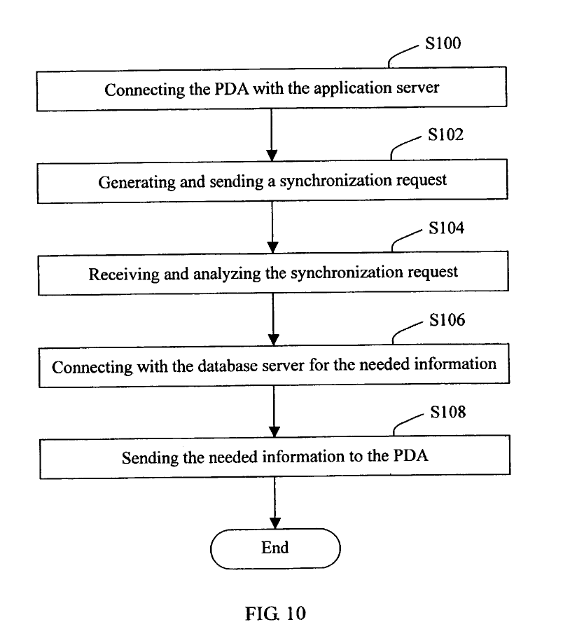

FIG. 10 is a flowchart of downloading information from the database server 107 to the PDA 101, in accordance with step S906 of FIG. 9 regarding synchronizing information. In step S100, the link-switching module 303 connects the PDA 101 with the application server 103. In step S102, the data synchronization module 309 of the PDA 101 generates a synchronization request according to a detailed demand input by the user, and sends the synchronization request to the application server 103. In step S104, the communication module 1031 of the application server 103 receives the synchronization request, and stores the synchronization request in the cache manager 1034. The first data filter module 1038 of the replication manager 1035 analyzes the synchronization request, and the domain manager 1036 determines the domain of the synchronization request. In step S106, the data access module 1037 connects with the database server 107 to obtain information needed to meet the synchronization request based on the results of analysis by the first data filter module 1038. In step S108, the application server 103 stores the needed information in the cache manager 1034, and sends the needed information to the PDA 101 via the communication module 1031. It is to be noted that a procedure of uploading information from the PDA 101 to the database server 107 is similar to the above-described procedure for downloading of information, with due alteration of details.

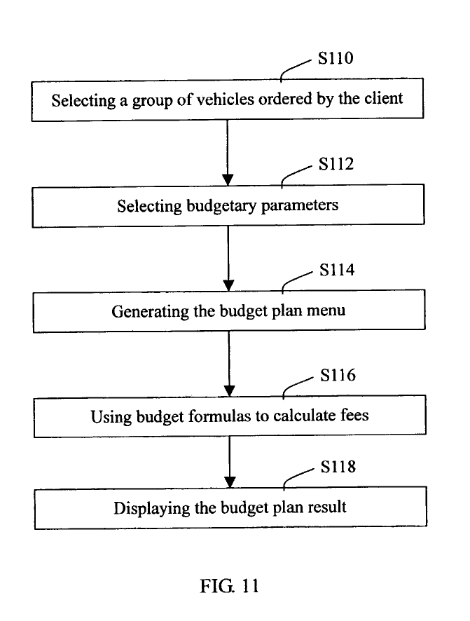

FIG. 11 is a flowchart of details of steps S912 and S914 of FIG. 9, namely generating a budget plan menu and calculating a budget plan result. In step S110, the user selects a group of vehicles reserved by the client. In step S112, the user selects a budget outline such as an installment budget. The user can select a down payment, a period for making payments, an interest rate, and other budgetary parameters. In step S114, the budget plan menu generating sub-module 3066 generates the budget plan menu for the client to conveniently select a budget plan best suited for him/her. In step S116, the budget module 306 uses the preset formulas stored in the data storage 301 to calculate relevant fees relating to the vehicles. In step S118, the budget module 306 displays the budget plan result on the screen of the PDA 101.

In general, the system and method for providing budgets for vehicle sales of the present invention may take forms other than what is described above. While preferred embodiments for carrying out the invention have been described in detail, those familiar with the art to which the invention relates will recognize various alternative designs and embodiments for practicing the invention. These alternative embodiments are within the scope of the present invention. The scope of the present invention is defined by the claims appended hereto and allowable equivalents thereof.

What is claimed is:

1. A system for providing budgets for vehicle sales using a mobile computing device, the system comprising an application server, a database server connected with the application server by a network, and a plurality of mobile terminals connected with the application server by a communication channel, wherein:
each of the mobile terminals comprises a budget module, a link-switching module, a data synchronization module, a data filter manager module, and a data storage, wherein:
the data storage is used for storing information on clients, vehicles, employees and budget definitions;
the link-switching module is used for switching states of connection as between the mobile terminal and the application server, said states of connection comprising a connected state and a disconnected state;
the budget module is used for calculating fees relating to vehicles within the purview of a client, using budget definition information stored in the data storage;
the data synchronization module is used for downloading information for synchronization from the application server, and for storing the downloaded information in the data storage; and
the data filter manager module is used for filtering modification of data stored in the data storage, said modification performed when the mobile terminal is in the disconnected state, and for sending data thus modified to the data synchronization module.

2. The system for providing budgets for vehicle sales using a mobile computing device as described in claim 1, wherein the budget module further comprises an installment budget sub-module, a government fees budget sub-module, an insurance payment budget sub-module, and a budget plan menu generating sub-module.

3. The system for providing budgets for vehicle sales using a mobile computing device as described in claim 1, wherein each of the mobile terminals further comprises an information searching module for searching information stored in the data storage.

4. A method for providing a budget for a vehicle sale using a mobile computing device, the method comprising the following steps:
(a) selecting from a data storage information on a vehicle within the purview of a client, including information on fees relating to the vehicle;
(b) selecting one or more budgetary parameters;
(c) generating a budget plan menu for the client to conveniently select a budget plan best suited for the client; and
(d) using one or more preset formulas to calculate fees payable in relation to the vehicle, and displaying a budget plan result on the mobile computing device.

5. The method for providing a budget for a vehicle sale using a mobile computing device as described in claim 4, wherein the one or more preset formulas are stored in the data storage.

6. The method for providing a budget for a vehicle sale using a mobile computing device as described in claim 4, further comprising the step of:
outputting the budget plan result.

7. The method for providing a budget for a vehicle sale using a mobile computing device as described in claim 4, wherein said fees payable comprise installment payments, government fees, and insurance fees.

8. A method of providing a budget for a vehicle sale using a mobile computing device, comprising steps of:
providing a mobile computing device communicating with a central database under online and offline statuses wherein said mobile includes a filter manager module to filter modified data stored in a data storage of the computing device in an offline status and a synchronization module uploading and downloading data to synchronize data between the central database and the mobile computing device;
linking the mobile computing device and the central database via networks;
selecting updated data information on a vehicle including fee information;
selecting one or more budgetary parameters;
generating at least one budget plan according to said budgetary parameters and choosing one which meets best of a specific client's desire.

9. The method as described in claim 8, further including step of uploading data information from the computing device to the central database after generation of the budge plan.
